(19) United States
(12) Patent Application Publication
(10) Pub. No.: US 2009/0300162 A1
(43) Pub. Date: Dec. 3, 2009

(54) System and method for performing mobile services, in particular push services in a wireless communication

(76) Inventors: Maria Lorenza Demarie, Torino (IT); Luca Lattore, Torino (IT); Giuseppe Lobello, Torino (IT); Mauro Rossotto, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/921,014

(22) PCT Filed: May 26, 2006
(86) PCT No.: PCT/EP2006/005011

§ 371 Date: Jun. 24, 2009

(30) Foreign Application Priority Data
May 27, 2005 (IT) PCT/IT2005/000306

(51) Int. Cl. G06F 15/173; G06F 15/16

(52) U.S. Cl. 709/224; 709/227; 709/226; 709/223

(57) ABSTRACT

An intermediate component is intermediate between mobile terminals requesting a service, such as a push service, and a service-providing server, such as an HTTP server. The intermediate component is a connection machine or hub that is able to open a session the first time it receives a request from a mobile terminal, by instantiating a communication channel for performing the communications with the mobile terminal and storing the data regarding the open session in a connection table. Then, the connection hub generates a request to a service-providing server, including connection data, and manages the communication with the service-providing server. The connection data are inserted in every communication between the connection hub and the mobile terminal and between the connection hub and the service-providing server. From that moment on, all the data (messages, requests) exchanged between the terminal and the service-providing server are routed on the instantiated channel, thus in a fast and efficient way.

### TECHNICAL FIELD OF THE INVENTION

The present invention relates in general to the field of wireless communication networks providing mobile services, and in particular to a system and a method capable of performing push and/or pull services for mobile terminals. More particularly, the invention relates to a solution allowing executing push and/or pull services simultaneously with performing video streaming, however without being limited thereto.

### BACKGROUND ART

As is known, services are software applications that, when activated by a specific input, output data or content (generally identified hereinafter as information) in a preset format. Mobile services are services that are provided to or through mobile terminals of a wireless network, such as handheld or cellular phones.

At the moment, there are two main modes for providing mobile services:

PULL MODE: the user accedes the service through an interface, inputting the data necessary for performing a request; for example, in a news service, the user can input the desired category. Generally, after an elaboration time depending on the service and on the capacity of the network and of the user (context), the user receives a response containing the requested information (for example, the last five news in the category “sport”).

PUSH MODE: in this mode it is the service that initiate the operations necessary to transfer information to the user. Normally, in an initial registration phase, the user supplies the inputs necessary to drive the service operation. For example, in a news service, the use can establish the most interesting categories and in case the maximum number of news to be received or the desired time slots; the service, using these inputs, forwards the news each time they are available (push), complying with the rules given by the user.

In the mobile radio environment, at least two factors render the PUSH mode very interesting for a broad class of services. First, the service provider can transmit to the user information/data without any specific request from the user. Secondly, the mobile terminal is used in a personal way, sometimes shared with others. Indeed, in the PUSH mode, it is assumed that the information, when available, is used by the subscribing user.

However, the PUSH mode can be provided in an efficient way only in a IP (Internet Protocol) network, while the ability of reaching a user is ensured by the mobile network (GSM-Global System for Mobile communications or UMTS-Universal Mobile Telecommunication System). In the mobile network, the user is identified by and can be reached through a telephone number (MSISDN-Mobile Station Informational ISDN Number), while the IP network can reach the user only after being requested by an application of the terminal.

A known solution for performing PUSH service via WAP (Wireless Application Protocol) uses SMS (Short Messaging System). In this case, as described e.g. in http://epubl.luth.se/1402-1617/2002/107/LTU-EX-02107-SE. pdf, a basic scenario of a push session is that a push initiator transmits content to a WAP client. To this end, the push initiator communicates to PPG (Push Proxy Gateway) which then delivers an URI (Uniform Resource Identifier) to the client via a Short Message System Center. Then the client activates the URI and gets the content from the specified server, using a Pull Gateway, that may-be the same as the PPG.

Applicant has noted that the above solutions based on SMS are affected by some drawbacks. First, the receipt of the SMS by the user terminal is not ensured, and if the SMS is get lost, no push service may be carried out. This situation may occur, for example, when the user terminal is used mainly for non-phone activities, such as for receiving video contents in streaming. In this case, the radio resource is dedicated to the non-phone activity and may not be able to receive messages using standard GSM techniques. This means that, during a streaming session or any other IP session that requires a high service quality, the receipt of SMSs can be interrupted by the user terminal, up to the end of the high-quality session. This behavior depends also on the class of the mobile terminal, for example according to the 3GPP technical specifications covering the GSM (including GPRS and EDGE) specifications.

As known, the classification of the terminals according to the specifications 3GPP (see document 3GPP TS 22.060 V6.0.0 2003-03, e.g. at: http://www.arib.or.jp-/IMT-2000/V440Mar05/5 Appendix/Rel6/22/22060-600.pdf) provides for three different classes:

Class A: The mobile station (MS) or terminal is attached to both GPRS and other services. The MS supports simultaneous attach, simultaneous activation, simultaneous monitor, simultaneous invocation and simultaneous traffic. The mobile terminal can make and/or receive calls/sessions on the two services simultaneously subject to the QoS requirements.
Class B: The MS is attached to both GPRS and other services, but the MS can only operate one set of services at a time. When the MS is in both idle mode and packet idle mode it should be able to monitor paging channels for both circuit-switched and packet-switched services depending on the mode of network operation.
Class C: The MS is attached to either GPRS or other services. Alternate use only. If both services (GPRS and Circuit Switched Network) are supported then a Class C MS can make and/or receive calls only from the manually or default selected service, i.e., either GPRS or Circuit Switched service. The status of the service which has not been selected is detached i.e., not reachable. The capability for GPRS-attached class-C MSs to receive and transmit SMS messages is optional.

This means that only the A-class terminals ensure the receipt of SMS during data connection of any type. B-class and C-class terminals do not allow for the simultaneous access to both circuit and packet-type services and thus delay the delivery of SMS messages of a push session that may occur during a packet-type connection. However, presently, A-type terminals are generally not present on the market, so that in practice all available terminals have the above mentioned drawback.

Furthermore, mobile services providing the delivery of a relatively high number of pushes simultaneously with a streaming have the following shortcomings:

the activation of a data connection after every push notification in a packet-type mobile network (e.g., GPRS-General Packet Radio Service, EDGE-Enhanced Data GSM or UMTS-Universal Mobile Telecommunication System) is typically very time consuming (it requires a round trip of about 4 s); and

the receipt of short messages while the terminal is taken up in a packet-type transmission (when possible) may bring to a considerable deterioration of the transmission, in particular in case of audio or audio/video streaming.

In the alternative, the push service may be performed through MMS (Multimedia Messaging System) or by means of an IP Listener.

The MMS solution may be implemented as the above described SMS solution, but the access to the IP network may be performed automatically and in a transparent way for the user. However, the Applicant has noted that the MMS solution shares the same disadvantages of the SMS solution; in particular also this solution is not able to ensure the delivery time of the MMS; furthermore, the quantity of data transferred is limited by the standards and by the terminal capacity.

IP listeners are used for handling IP connection requests from the data sources and for directing the connection to a particular port. IP listeners are often referred to as TCP/IP listeners if they use the Transmission Control Protocol (TCP) as transport protocol at the Transport Layer of the International Standards Organization (ISO) Open System Interconnect (OSI)—ISO/OSI—reference model. Another transport-level protocol is User Datagram Protocol (UDP). In the solution using a Listener IP, the user terminal needs to permanently perform an application which is always “listening” to the IP network. Such a solution would require considerable hardware/software resources that are generally applicable in powerful software environments, such as Personal Computers. Thus, at the moment, this solution is not applicable in the software environments available in mobile terminals.

U.S. Pat. No. 6,877,036 discloses a system and a method for managing connections between a plurality of clients and a server by off-loading much of the connection management burden from the server's main processor with a proxy application run on a different processing unit.

A general system including a web server able to perform mobile services is described in http://msdn microsoft.com/library/default.asp?url=/library/en-us/dnnetcomp/html/NETCFMA.asp and in article http://plato.csse.monash.edu.au/MobileWebServer/pervasive3.pdf. Here, the web server is intended to run on a Pocket PC and is partitioned into a Compact Listener, a Core Server and Supporting Modules, wherein the Compact Listener is the highest level component that is responsible for managing client requests on a particular port; Core Server is the primary component of the framework that receives encapsulated HTTP requests from the Compact Listener, performs the necessary validations and determines the appropriate Supporting Modules to forward these requests to; and the Supporting Modules represents the implementation of a particular internet protocol (that is, HTML, SOAP and others).

Applicant has found that this solution requires terminals having high capacity, like Pocket PC. Moreover, the described solution is not tailored to deploy push services, its main application being the access to local resources and/or data of the terminal from a PC or other device connected to the internet.

Thus, a solution is needed to performing push and pull services in a simple way, such as to ensure that the user actually exploit them with presently available devices and in acceptable times.

### OBJECT AND SUMMARY OF THE INVENTION

The aim of the present invention is therefore to provide a system and a method for performing mobile services, such as push and pull services, that are able to overcome the above drawbacks of the known solutions.

According to the present invention, there are provided a system and a method for performing mobile services in a wireless communication network, as defined in claims 1 and 12.

In practice, the system comprise an independent component intermediate between the mobile terminal and a server, in the preferred embodiment an HTTP server. The intermediate component is a connection machine or hub that is able to open a session the first time it receives a request from a mobile terminal, by instantiating a connection or socket channel for performing the communications with the terminal and storing the data regarding the open session. Then, the connection hub generates a request to a service-providing server and manages the communication therewith. From that moment on, all the data (messages, requests) exchanged between the terminal and the service-providing server are routed on the instantiated channel, thus in a fast and efficient way.

Since the computing job necessary to implement the mobile (push and pull) services is executed externally to the mobile terminal, the latter can be a component of a low class (class B or C of the above cited specifications 3GPP), thus allowing all the mobile terminals having the capability of performing transmissions and having limited processing capabilities to use push and pull services. Furthermore, the present solution allows execution of push and pull services also simultaneously with data transmission of the circuit (e.g., GSM) or of the packet type (GPRS/GSM).

Since the listening function is performed by the connection hub and the data of the open session are stored therein for use in any later moment, the connection hub is able to operate as a “listener IP” for a plurality of mobile terminals, each of which may open an own session and have socket channels dedicated thereto.

### BRIEF DESCRIPTION OF THE DRAWINGS

For a better understanding of the present invention, a preferred embodiment, which is intended purely as an example and is not to be construed as limiting, will now be described with reference to the attached drawings, wherein:

FIG. 1 shows a block diagram of a wireless network including the system according to an embodiment of the present invention;

FIG. 2 is a block diagram of a component of the system of FIG. 1;

FIG. 3 is a flow-chart of the operation of the present system for performing a push service;

FIG. 4 is a table showing a possible structure of a message sent to the mobile terminal, either push data or response to a pull request;

FIG. 5 is a flow-chart of the operation of the present system for performing a pull service; and

FIG. 6 is a table showing a possible structure of a message sent from the mobile terminal, either a pull request or a session control message.

### DETAILED DESCRIPTION OF PREFERRED EMBODIMENTS OF THE INVENTION

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein and defined in the attached claims.

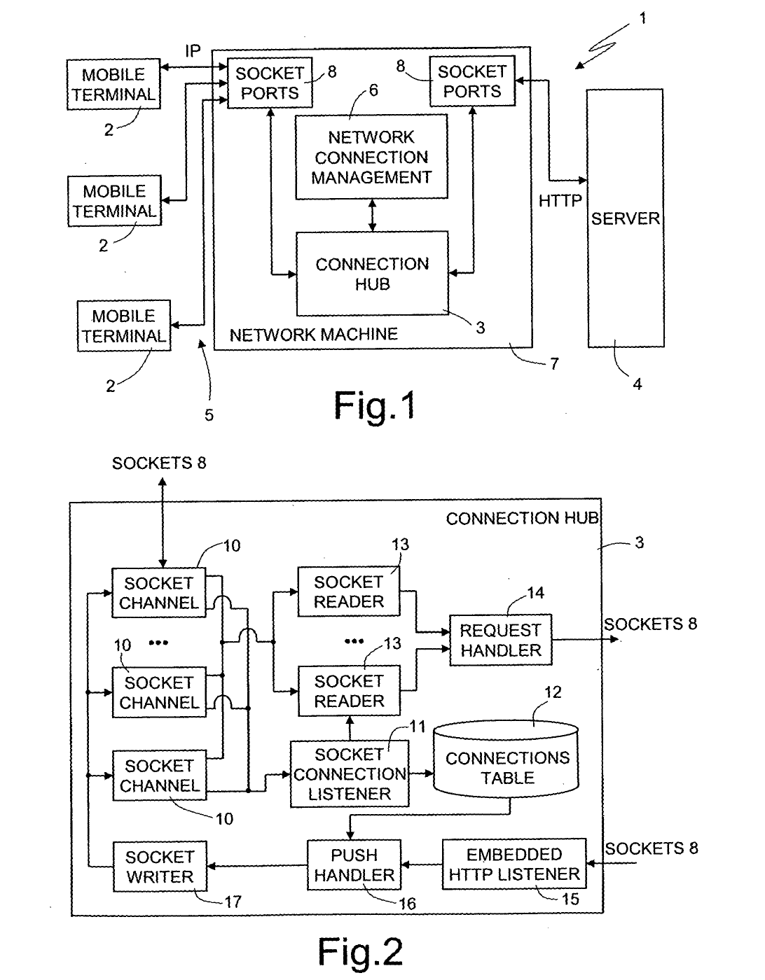

FIG. 1 shows an embodiment of the present system for performing mobile (push/pull) services. The system 1 includes a plurality of mobile terminals 2, a connection hub 3 and at least one server 4.

The mobile terminals 2 are radio terminals (handsets) connected to the connection hub 2 through a wireless network 5. The mobile terminals 2 may be e.g. smartphones that are able to communicate with the connection hub 2 through an IP communication link and have some multimedia capabilities, such as the ability of playing audio or audio/video streaming, using for example the RTSP protocol, or progressive download. The mobile terminals 2 are able to perform applications that are either initiated by a user or are performed automatically upon the user performing some actions (pushing a button, actuating a function, etc.) and involve service requests to be forwarded to the server 4, such as push and/or pull requests. In the alternative, the session may be started at once upon switching-on the mobile terminal 2, so as to be immediately operative when performing of a service, such as a push or pull service, is requested. In the following, the term mobile terminal 2 will be used to identify all the both the physical apparatus and the applications performing transactions with the server 4 through the connection hub 3.

The connection hub 3 has the function of performing the IP listening functions related to specific mobile services, such as push and pull services, and is a component intermediate between and distinct from the mobile terminals and the server 4. The connection hub 3 is implemented in a machine 7 that may be a dedicated server. In the alternative, the machine 7 may be implemented by the server 4 itself, in which case, however, the connection hub 3 is distinct from the server components dedicated to the implementation of the service logic. The connection hub 3 includes a plurality of components that are mainly software applications, each dedicated to a specific task. Furthermore, the connection hub 3 cooperates with standard modules (generally indicated at 6) that manage the network connection and, in particular, obtain the TCP/IP identification data of the terminal (including the terminal IP address and the port), optionally authenticate the mobile terminals 2 and so on. The machine 7 also comprises socket ports 8 that physically receive/transmit data and messages from/to the mobile terminals 2 and the server 4.

The server 4 is an application-level server, in particular an HTTP server, that implements the considered service and thus is able to send the information (data/content) provided by the push/pull service, in a per se known manner, not described in greater detail. If the communication network so allows, more servers 4 are provided, each dedicated to a different service. For this reason, the or each server 4 may be also identified as a “service provider”.

According to an embodiment of the invention, as soon as a mobile terminal 2 runs an application requesting a service from the provider 4, it activates a connection to the mobile packet network, such as the GPRS, and sends the data necessary for its recognition, as explained in more detail hereinafter.

From the network connection so activated, the connection hub 3 obtains the information related to the specific connection and instantiate an inner communication channel. The information related to the specific connection includes the client socket address, i.e., the terminal IP address and port, which allows the terminal to be reached by the connection hub. After performing some data processing, better specified later on, the connection hub 3 sends the necessary data to the server 4 including an URL HTTP referencing the IP address and port of the connection hub 3 and containing necessary data to identify the client. Identity data of the client can include the socket address (i.e., the terminal IP address and port). However, in the preferred embodiments, client identity data to be supplied to the server include an identity of the client within the communication network to which the client is connected to, for example a GPRS-GSM network, when requesting the application service. Such a client identity data will be hereafter referred to as the session-independent identity data. The session-independent identity data has the advantage of being independent of the IP mapping associated to the client within a particular session. In other words, it is univocally associated to a client, e.g. a subscriber of the GPRS-GSM network, for more than one session.

In a preferred embodiment, the session-independent identity data is the Mobile Station International ISDN Number, or MSISDN, of the subscriber of the mobile network. The service provider, by gaining knowledge of the MSISDN of the client requesting the service, can associate this identity data to a subscriber profile that can be stored in the server.

The session-independent identity data can be also the International Mobile Equipment Identity, or IMEI. However, the MSISDN is preferred because it is univocally related to the subscriber, independently of the terminal device is using for the connection

Said URL HTTP is used for any subsequent transmission of data from the server 4 to the mobile terminal 2. After the opening of the session, a message from the server will be transmitted to the connection hub 3 by using the created URL HTTP that includes the hub IP address and port. Thereby, a new session is opened, which is kept open so until the terminal sends a specific end message.

The operation of the connection hub 3 will be explained in more detail hereinbelow with reference to FIG. 2 showing an embodiment thereof.

According to FIG. 2, the connection hub 3 comprises a plurality of socket channels 10; a socket connection listener 11; a connections table 12; a plurality of socket readers 13; a request handler 14; an embedded HTTP listener 15; a push handler 16; and at least one socket writer 17.

The socket channels 10 are standard communication connection channels, e.g., TCP/IP socket channels, which are assigned to the mobile terminals 2 as soon as the latter activate a session. As known, a connection channel is uniquely identified by a pair of sockets at each end of the connection. As known, the sockets are addressable entities, known per se, and each socket is identified by a socket descriptor, i.e., the file descriptor for the socket process. Each socket descriptor contains the remote IP address and the remote port number, i.e., the remote socket address, wherein the term “remote” refers to the IP address and port of the remote end of the connection. Thus, at the connection hub 3 end, the remote IP address and the remote port are the client IP address and port.

Therefore, the socket channels 10 represent the physical (even though logical) connection between the mobile terminal 2 and the connection hub 3 which, once a session has been opened, is unique. Once a socket connection is established, i.e., the connection channel 10 is instantiated, it supports symmetric, two-way communication between the mobile terminal 2 and the server 4 or a plurality of servers 4.

The connection listener or socket connection listener 11 has the responsibility of managing the connection with the mobile terminals 2 belonging to the network 5, as explained in greater detail later on.

The connections table 12 stores the information regarding all the mobile terminals 2 which have an open session; in particular, it stores the association between each active mobile terminal (identified from its identity data) and the socket channel 10 assigned thereto.

The socket reader elements or socket readers 13 have the function of extracting the data supplied by a mobile terminal 2 through the associated socket channel 10, each time a mobile terminal 2 transmits them to the connection hub 3 (e.g. when requesting a pull service).

The request handling element or request handler 14 has the function of processing the requests coming from the mobile terminals 2 and forwarding them in the appropriate standard, e.g., HTTP, Simple Object Access Protocol (SOAP) or Simple Mail Transfer Protocol (SMTP), to the server 4. Together, socket connection listener 11, the socket readers 13 and the request handler 14 form a connection manager that manages the connection from the mobile terminal 2 toward the server 4.

The embedded HTTP listener 15 has the function of listening to and receiving the HTTP messages generated by the server 4 and possibly including messages for the mobile terminals 2 and thus operates as an embedded service listener. The embedded HTTP listener 15 is thus a core component of the connection hub 3 that actually performs the IP listening task and is set up to listen on the hub IP address and port.

The push handler 16 has the function of processing the messages received from the server 4 through the embedded HTTP listener 17 and thus operates as a service handling element.

The socket writer 17 has the function of writing the data to be forwarded to the mobile terminal 2 through the associated socket channel 10. Together, the embedded HTTP listener 15, the push handler 16 and the socket writer 17 form a service handling manager that manages the connection from the server 4 toward the mobile terminal 2.

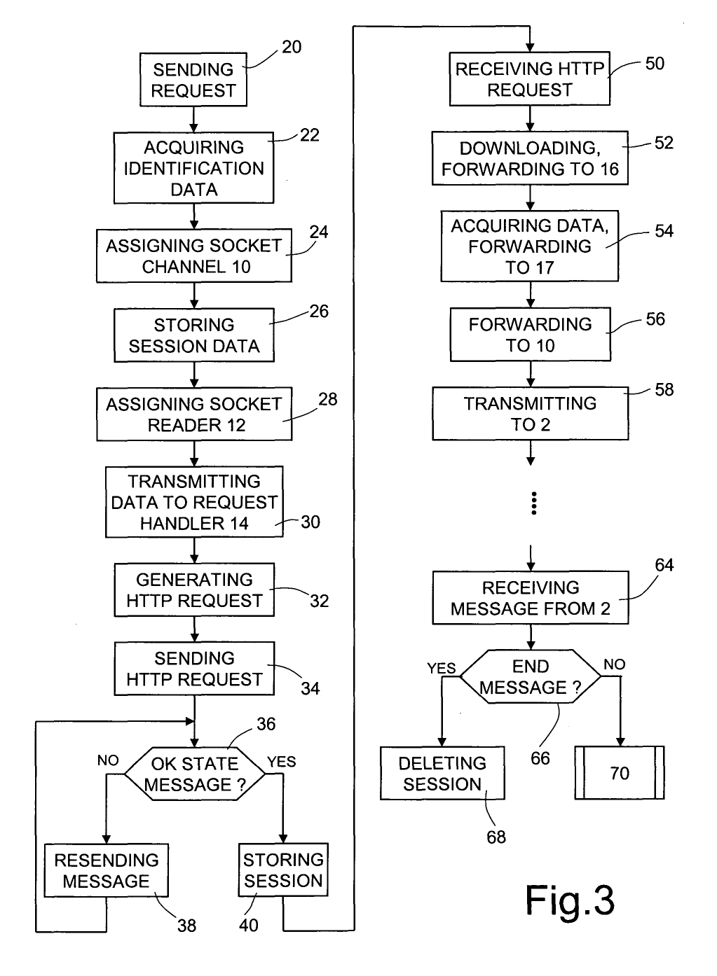

The operation of the connection hub 3 of FIG. 2 for performing a push service is described hereinbelow, making also reference to the flow-chart of FIG. 3.

In order to declare its willingness to receive PUSH services, a mobile terminal 2 sends the data necessary for its identification as recipient and/or requester of transmission data. These data include the IP address associated to the mobile terminal at the opening of the session. Preferably, the terminal 2 sends also the data necessary for recognition of the user (e.g., MSISDN) or of the terminal the user is employing (e.g. the IMEI—International Mobile Equipment Identity—code).

Other data can be sent by the terminal for performing the push service (e.g., the so-called User Agent of the application, including the operative system, the type of terminal, the version of the application and so on). Furthermore, the mobile terminal 2 can send data identifying the network type it uses (for example, GPRS-General Packet Radio Service, EDGE—Enhanced Data GSM or UMTS—Universal Mobile Telecommunication System).

These data are received by the socket connection listener 11 as soon as it recognizes a new request for a session. The session-independent identity data of the mobile terminal 2, instead of being provided by the terminal, can be acquired by the connection hub 3 by acceding an access authentication system, such as the RADIUS-Remote Authentication Dial-In-User, or the VLR—Visitor Location Register of the GSM network where the MSISDN of the subscriber is stored, here considered incorporated in the management block 6 of FIG. 1, step 22.

Then, the socket connection listener 11 instantiates a socket channel 10 (that is not yet busy) to the mobile terminal 2 that has requested the service, step 24. From this moment on, the instantiated socket channel 10 is dedicated to all the subsequent communications to and from the same mobile terminal 2 (session opened). Furthermore, the socket connection listener 11 sends the just acquired connection information to the connection table 12 for storing, step 26. In particular, the following information is stored in the connection table 12 for each connection (connection data):

Mobile terminal IP address and the port on which the mobile terminal 2 has activated the connection, i.e., the socket address at the terminal end of the connection channel, so that the open session is univocally identified, and

Instantiated socket channel 10, i.e., the socket descriptor of the instantiated socket channel 10 containing the information at the transport level and typically also at the lower level, e.g., the network level (according to the ISO/OSI), necessary to route the message along the socket channel 10 to the mobile terminal 2.

Additionally, the following information is stored in the connection table 12:

IMEI or, more preferably, MSISDN.

Optionally, the following information can be stored in the connection table 12:

User Agent

Network Type

Session-independent identity data, such as the MSISDN and the IMEI, can be used by the server 4 in order to provide services tailored to a particular subscriber, e.g., by associating the MSISDN to a user profile database, or to the terminal employed by the subscriber, e.g., in order to adapt the data content to the type of terminal equipment.

Then, the instantiated socket channel 10 is associated to an available socket reader 13, step 28; thereby the latter actually extracts the data necessary for the connection (i.e., the mobile terminal IP address and port) and stores them in a connection table 12. Identity data are forwarded by the socket reader to the request handler 14, step 30; the request handler 14 then generates the actual HTTP request, step 32, and sends it to the server 4, step 36. In particular, the request handler 14 sends a message to the server 4 and attaches thereto the connection and the validation data as well as an URL to be used for the subsequent push transmissions to be sent to the mobile terminal 2 and including identification data.

An example of a URL HTTP supplied to the server 4 by the connection hub 3 for use to contact a mobile terminal 2 is the following:

http://hub-ip:hub-port/push/client-MSISDN

wherein

hub-ip is the IP address of the connection hub 3;

hub-port is the port of the connection hub 3 to be used for communicating within the specific open session;

/push indicates the type of service offered by the specific connection hub 3;

wherein the MSISDN represents the data identifying the terminal.

It is to be understood that, although it is preferred that the connection hub communicates as client identification data the MSISDN, the URL HTTP supplied to the server 4 can be also

http://hub-ip:hub-port/push/client-ip:client-port, wherein client-ip is the IP address of the mobile terminal 2 and client-port is the port of the mobile terminal 2.

Then, the server 4 responds with a state message to indicate whether the request has been correctly received.

In particular, the state message may be:

200=HTTP_OK

in case of correct receipt or

500=HTTP_INTERNAL_SERVER_ERROR

in case of an error.

The connection hub 3 receives the state message and checks it, step 36. If the message is incorrectly received, the request handler 14 resends the message, step 38.

When the message is correctly received, the relative data are stored by the server 4, step 40, and the communication is interrupted until the server 4 has to send a push transmission to the mobile terminal 2.

Whenever the server 4 has to send a push transmission to the mobile terminal 2, it sends an HTTP request to the connection hub 3. In a preferred embodiment, the push message is formed by a set of content components formed by text and/or video. and/or audio (multimedia content) and by a presentation logic. Data attached to the HTTP request are sent in POST in a suitable format, such as a multi-part file. For example, a possible technique that may be used for delivering information packets attached to a push message is described in WO 2004/095794.

The arrival of a push message on a socket port 8 of the connection hub 3 is listened by the embedded HTTP listener 15, step 50, which downloads the data and forwards them to the push handler 16, step 52.

The push handler 16, on the basis of the data in the HTTP request (i.e., from the URL HTTP), acquires, from the connection table 12, the data necessary to forward the push data to the mobile terminal 2; in particular, the push handler 16 reads the identification of the socket channel 10 instantiated to the specific session, and carries out any data transformation and optimization, as provided for by the client communication protocol. Then the push handler 16 sends the data to the socket writer 17, step 54.

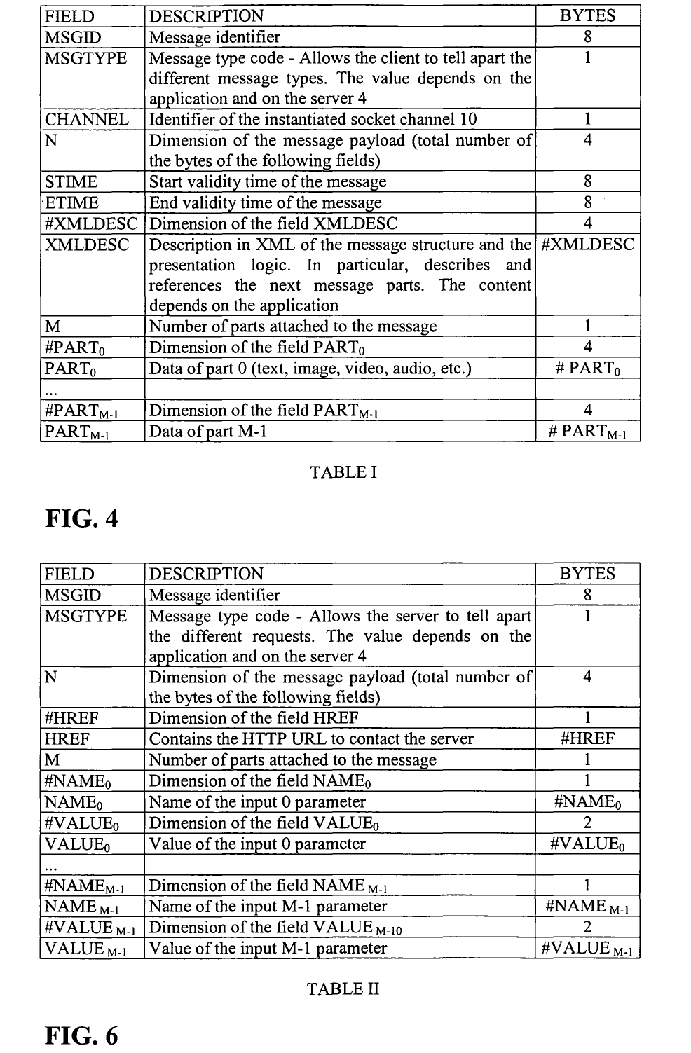

The socket writer 17 transforms the data in the format of the mobile terminal 2 (e.g., in the format and including the fields specified shown in Table I, FIG. 4) and sends them to the previously instantiated socket channel 10, step 56; the socket channel 10 provides for the actual forwarding to the mobile terminal 2, step 58.

Thereby, in this example, the mobile terminal 2, on the basis of the description in XML, is able to interpret all the components of the message and perform the rendering thereof through a suitable viewer or player.

A session is closed when the mobile terminal 2 sends an end message to the connection hub 3, for example when the application running on the mobile terminal 2 is closed. As soon as the socket connection listener 11 receives a further message, step 64, it checks it, step 66, and, if it is an end message, it performs the actions necessary to close the session, step 68; in particular, it deletes the association mobile terminal 2/socket channel 10 from the connection table 12, thus the socket channel 10 becomes free for another session with the same or another mobile terminal 2.

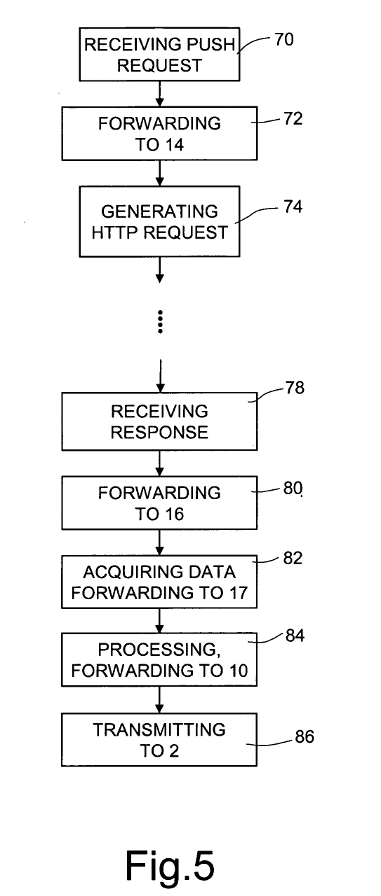

If the message is a request message for a different service, e.g. a pull service, the connection hub proceeds with the appropriate steps, e.g. it proceeds with step 70 (FIG. 5).

The structure of the connection hub of FIG. 2 allows also to carry out other types of services, such as activate further push requests and perform pull service requests, wherein the messages sent by the server 4 to the mobile terminal 2 represent specific responses to the mobile terminal 2.

An example of the operations involved in a pull service is described hereinbelow, with reference to FIGS. 2 and 5.

Once a session is open (or after opening of a session according to steps 20-38 of FIG. 3), whenever a mobile terminal 2 wants to obtain a pull service from the server 4, it first collects the necessary inputs, and codes them as a message. Then, the mobile terminal 2 sends a message, in the TCP/IP protocol, to the connection hub 3 introducing the byte of the coded request in the already opened socket channel 10. In this step, the mobile terminal 2 uses the information of the open session (including the HTTP URL) from the previous push request. An example of a format of a pull message sent by a mobile terminal 2 is shown in Table II of FIG. 6. Then, the mobile terminal 2 sets in a waiting state.

Once the connection hub 3 receives the message from the mobile terminal 2, step 70, the socket reader 13 cause the message to be forwarded to the request handler 14 through the previously instantiated socket channel 10, step 72. Then, the request handler 14 generates an HTTP request to the server 4, using the data of the message sent by the mobile terminal 2, step 74. In particular, with reference to Table II of FIG. 6, the HTTP URL is taken directly from the field HREF of the pull message, all the M input parameters are forwarded as HTTP parameters in POST; the message identifier MSGID and the request type

As soon as the server 4 receives the request, it processes it and sends the response to the connection hub 3. As soon as the connection hub 3 receives the response, step 78, it proceeds in the same way as above described with reference to a push service, including:

listening to the arrival of a message, downloading and forwarding the data to the push handler 16, by the embedded HTTP listener 15, step 80;

acquiring the necessary data from the connection table 12, treating and forwarding the data the socket writer 17 by the push handler 16, step 82;

transforming and forwarding the data to the previously instantiated socket channel 10 by the socket writer 17, step 84;

transmitting the data to the mobile terminal 2, step 86.

An example of a possible service that can make use of the above described system and method is the Interactive Mobile Television (IMTV). As known, an IMTV service resides in the receipt of audio/video content in streaming (for example, a live video broadcasted sent by a broadcaster, or a stored video played in a simulated-live way), associated to push messages that can be processed through pull interactions to a content server. Streaming can be transmitted by using for instance Real Time Streaming Protocol (RTSP) from a streaming server.

The IMTV service comprises a client application stored in a mobile terminal 2 such as a smart-phone; the application communicates through. the connection hub 3 with a server 4 which has the function of generating push messages associated to the television contents and responding to the interactive requests.

In this case, the mobile terminal 2 includes a user interface that may be divided into three areas:

TV area: area of a display dedicated to displaying video contents (TV streaming, streaming on demand; download & pay; play of local contents);

Push area: area intended for displaying informative contents, suggestions, different information with low multimedia level but able to lock to applications with high interactivity level or with external functions;

Interactive area: intended to allow interactivity and complete browsing with full control.

Whenever the user requests activation of a push or a pull service through the push or the interactive area, the mobile terminal 2 sends the respective request that is handled by the system as above described with reference to FIGS. 1-6.

The system and method as described have the following advantages.

Since the connection hub 3 (that is resident on server machines located e.g. in a service center) is in charge of the processing load for listening, treating and forwarding the push and pull requests, the solution may be generally applied to the smart phones currently available on the market.

The wide applicability of the present system derives also from the fact that communications between the mobile terminals 2 and the service 4 are performed on a packet type network; thus no transmission of confirmation messages is necessary and virtually all smart phones presently available on the market (classes B and C) can accede to the service.

The sending of a new push message does not requires the opening of a new TCP/IP session between the mobile terminal 2 and the server 4; thereby, the long connection times on a mobile network are avoided.

The pull type requests (that may be very likely after receipt of a push message, for example to obtain more information not available in the push message) do not require opening of a new session.

The connection hub 3 may simultaneously manage a plurality of mobile terminals, with reduced costs.

Finally, it is clear that numerous modifications and variants can be made to the present invention, all falling within the scope of the invention, as defined in the appended claims. For example, at least some of the specific components of the connection hub could be implemented, instead of by the described software modules, by suitable hardware components, as long as they are able to perform the required tasks.

1-23. (canceled)

24. A system for performing mobile services in a wireless communication network, comprising a connection machine for receiving a first terminal request from a client and for generating a service request for a service provider, the connection machine comprising a connection manager for receiving said first terminal request;
said connection machine comprising a plurality of connection channels connected to said connection manager and a connection table connected to said connection manager;
wherein said connection manager is configured to generate an association between one of said connection channels and said client and to store association data regarding said association in said connection table, said association data comprising identity data of the client and identity data of said communication channel; and
wherein said connection manager comprises:
a plurality of socket reader elements, one of said socket reader elements being associated with said one connection channel and being configured to acquire said identity data of the client from said one connection channel; and
a request handling element for generating said service request comprising connection data and for sending said service request to said service provider, wherein said connection data comprise session-independent identity data of the client.

25. The system of claim 24, wherein said identity data of the client comprises a client internet protocol address and a client port.

26. The system of claim 24, wherein said session-independent identity data comprise the mobile station informational ISDN number or the international mobile equipment identity.

27. The system of claim 24, wherein said connection data comprise an HTTP URL.

28. The system of claim 24, wherein said connection data comprises an intent protocol address and a port of the connection machine.

29. The system of claim 24, wherein said connection manager further comprises a socket connection listener connected to said connection channels configured to instantiate said one communication channel and to store said association data in said connection table, wherein said plurality of socket reader elements are connected to said connection listener, said one of said socket reader elements being associated by said connection listener with said one connection channel.

30. The system of claim 24, wherein said connection machine receives a service-provider response message comprising said connection data, said connection machine comprising a service handling manager connected to said connection table, said service handling manager configured to receive said service-provider response message, to acquire said association data from said connection table based on said service-provider response message, to generate a terminal response message on the base of said service-provider response message and to forward said terminal response message to said client through said one connection channel specified by said association data.

31. The system of claim 30, wherein said service handling manager comprises an embedded service listener configured to receive said service-provider response message, a service handling element connected to said embedded service listener and said connection table, configured to acquire said association data from said connection table based on said service-provider response messages; and at least one socket writing element, connected to said service handling element and said connection channels, configured to receive said association data and said service-provider response messages, to generate said terminal response message and to send said terminal response message to said one connection channel.

32. The system of claim 30, wherein said connection machine is configured to receive a further terminal request from said client, said further terminal request comprising said connection data and being forwarded through said one connection channel to said service provider, and wherein said connection machine is configured to receive a further service-provider response message from said service provider, said service handling manager being configured to receive said further service-provider response message, to acquire said association data from said connection table and to send a further terminal response message to said client through said one connection channel.

33. The system of claim 24, wherein said first terminal request is an internet protocol request and said service request is an HTTP service request.

34. A method for performing mobile services in a wireless communication network, comprising the steps of receiving a first terminal request adapted for generating a service request for a service provider;
acquiring identity data of a client from said first terminal request;
generating one connection channel;
generating an association between said connection channel and said client;
saving association data regarding said association, wherein said association data comprises identity data of the client and identity data of said connection channel;
generating a service request for a service provider after the step of receiving said first terminal request, wherein the step of generating the service request comprises incorporating connection data comprising session-independent identity data of the client in said service request; and
sending said service request to the service provider.

35. The method of claim 34, further comprising, after the step of generating an association between said connection channel and said client, the step of opening a session comprising said association data.

36. The method of claim 34, wherein said service request comprises an HTTP URL.

37. The method of claim 34, wherein said session-independent identity data comprise the mobile station informational ISDN number or the international mobile equipment identity.

38. The method of claim 34, wherein said identity data comprises a client internet protocol address and a client port.

39. The method of claim 34, wherein said connection data comprises an internet protocol address and a port of the connection machine.

40. The method of claim 34, comprising the steps of
receiving a service-provider response message comprising said connection data from said service provider;
acquiring said association data from said connection table based on said service-provider response message;
generating a terminal response message on the basis of said service-provider response message; and
forwarding said terminal response message to said client through said one connection channel specified by said association data.

41. The method of claim 34, wherein said step of generating a service request for a service provider comprises:
associating a socket reader element with said one connection channel; and
causing said socket reader element to read said identity data from said first terminal request message, wherein said identity data comprise a client internet protocol address and a client port.

42. The method of claim 34, further comprising the steps of:
receiving a further terminal request comprising said connection data from said client;
forwarding said further terminal request through said one connection channel to said service provider;
receiving a further service-provider response message from said service provider;
acquiring said association data from said connection table; and
sending a further terminal response message to said client through said one connection channel specified by said association based on said service-provider response message.

43. The method of claim 34, wherein said first terminal request is a push request.

44. The method of claim 34, wherein said first terminal request is a pull request.

45. The method of claim 34, wherein said first terminal request is an internet protocol request and said service request is an HTTP service request.

46. The method of claim 34, comprising the steps of:
receiving end session data from said client; and deleting said association data.
